(19) United States
(12) Patent Application Publication
(10) Pub. No.: US 2004/0068544 A1
(43) Pub. Date: Apr. 8, 2004

(54) Multi-user e-mail client and alert schema

(75) Inventors: Dale W. Malik, Dunwoody, GA (US); W. Todd Daniell, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BellSouth Intellectual Property Corporation, Wilmington, DE

(21) Appl. No.: 10/326,249

(22) Filed: Dec. 19, 2002

Related U.S. Application Data
(60) Provisional application No. 60/416,916, filed on Oct. 8, 2002.
(60) Provisional application No. 60/426,440, filed on Nov. 14, 2002.

(51) Int. Cl. G06F 15/16

(52) U.S. Cl. 709/206

(57) ABSTRACT

A representative e-mail client includes a message retrieval component and a user interface logic. The message retrieval component is operable to retrieve a plurality of messages for a plurality of e-mail accounts from at least one e-mail server and store the plurality of messages in a storage system. The user interface logic is operable to parse the plurality of messages stored in the storage system according to an e-mail address associated with a respective message, and cause the plurality of parsed messages to be separately displayed to a user on a computer display. Methods and computer readable media for e-mail clients are also provided.

### CROSS-REFERENCE TO RELATED APPLICATIONS

This application claims priority to and incorporates by reference both copending U.S. provisional application entitled, “FUNCTIONAL SPECIFICATION FOR E-MAIL CLIENT,” having Ser. No. 60/416,916, filed Oct. 8, 2002, and copending U.S. provisional application entitled, “MULTI-USER E-MAIL CLIENT AND ALERT SCHEMA,” having Ser. No. 60/426,440, filed Nov. 14, 2002.

### FIELD OF THE INVENTION

The present invention is generally related to telecommunications and more particularly to e-mail services provided via computer applications.

### DESCRIPTION OF THE RELATED ART

The development of the internet has driven vast technological developments, particularly in the areas of networking hardware and software. Networking hardware developments have enabled networks to transfer large files in fractions of a second. Software developments, such as the world-wide-web (web) and e-mail, have facilitated communications over these networks that have enabled users to remain in almost constant contact with each other.

Although these networks were developed with business and academia in mind, internet service providers (ISPs) are now targeting general consumers with their services. However, these consumers are typically provided with the software that was developed for the business and academia communities. For example, Microsoft Windows, available from Microsoft Corp., of Redmond, Wash., is included on the vast majority of computers sold, and includes a program called Outlook. Outlook, however, does not readily recognize very well that there can be many family members who may each own his or her own e-mail account. Outlook would force the users to log-out and log back on in order to change e-mail accounts. Because the log-out-logon system is impractical, many families have gone to having only a single e-mail address for all family members. However, the impracticality here is that each family member can read each of the other family member's e-mail. Moreover, family members often must read all e-mail in order to determine to whom the e-mail is intended. In another popular e-mail program, Eudora, available from QualComm Inc., of San Diego, Calif., a user can install and open multiple instances of the same program, each having different settings, to access multiple e-mail accounts. This is generally impractical because it wastes system resources and can be confusing. Some e-mail programs also enable users to retrieve mail from several different POP3 mail accounts, but then mix all of the mail together.

Therefore, there is a need for systems and method that address these and/or other perceived shortcomings of the prior art.

### SUMMARY OF THE INVENTION

One embodiment, among others, of the present invention provides an e-mail client that includes a message retrieval component and user interface logic. The message retrieval component can retrieve messages for a number of e-mail accounts, including from varied e-mail servers, and store the messages in a storage system. User interface logic can parse the messages stored in the storage system according to an e-mail address associated with each of the messages, and cause the parsed messages to be separately displayed to a user on a computer display.

Another embodiment of the present invention provides a computer readable medium having programming for an e-mail client that performs the steps of: requesting any new messages for associated e-mail accounts from a respective e-mail server; storing the new messages in a data structure; parsing the data structure to separate the messages based on the associated e-mail accounts; and displaying a summary of the parsed data structure to a user based on a plurality of folders.

Other systems, methods, features, and advantages of the present invention will be or become apparent to one with skill in the art upon examination of the following drawings and detailed description. It is intended that all such additional systems, methods, features, and advantages included within this description and be within the scope of the present invention.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an embodiment, among others, of an e-mail architecture used to transfer e-mail between client computers.

FIG. 2A is a block diagram of an embodiment, among others, of the client computers of FIG. 1, including the e-mail client of the present invention.

FIG. 2B is a block diagram of an embodiment, among others, of the client computers of FIG. 1, illustrating some functionality of the e-mail client.

FIG. 3 is a diagram of an embodiment, among others, of a data structure that can be used in the storage area of FIG. 2B.

FIG. 4 is a generic screen shot of an embodiment, among others, of the e-mail client of FIG. 2B, included in the present invention.

FIG. 5 is a detailed screen shot of an embodiment, among others, of the e-mail client of FIG. 2B, included in the present invention.

FIG. 6 is a sample screen shot of an embodiment, among others, of a set-up window of the e-mail client of FIG. 2B, used to set up different mailboxes.

FIG. 7 is a flowchart illustrating the operation in one embodiment, among others, of a portion of the e-mail client of FIG. 2B.

### DETAILED DESCRIPTION OF THE PREFERRED EMBODIMENTS

The preferred embodiments of the present invention now will be described more fully with reference to the accompanying drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

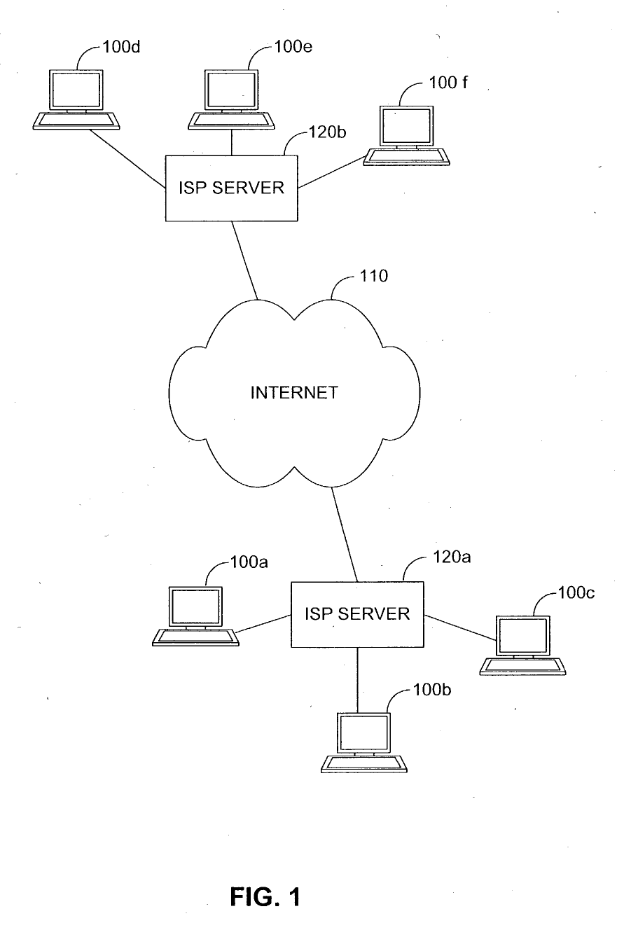

Referring now to FIG. 1, shown is a block diagram illustrating an architecture used for e-mail transport and delivery used in one embodiment, among others, of the present invention. Each of a plurality of remote computers 100a-f access the internet 110 (or other network) through a local internet service provider (ISP) server 120a, 120b (or other gateway systems). It should be recognized by one skilled in the art that the ISP server 120a, 120b can offer access to the internet 110 through a plethora of connection types, including a digital subscriber line (DSL) service, an integrated services digital network (ISDN) service, an analog dial-up service, ethernet, T-1, or any other service for transmitting data through a network. Each of the ISP servers 120a, 120b, in turn, are connected to the internet 110. This internet connectivity enables the ISP servers 120a, 120b and other servers connected to the internet to transfer information amongst the servers 120a, 120b using various universal protocols recognized by the servers.

With specific regard to e-mail, the ISP servers 120a, 120b generally include both a post office protocol 3 (POP3) server and a simple mail transfer protocol (SMTP) server with a multipurpose internet mail extension (MIME). Typically, the e-mail client on computers 100a-f include a POP3 component and an SMTP component with MIME encapsulation for non-ascii attachments. The SMTP component on a computer 110a-c will transfer an e-mail message in the SMTP format to the SMTP server residing on an ISP server 120a. The SMTP server then transfers it to the correct ISP server 120b where it is stored on the POP3 server. Alternatively, one skilled in the art should recognize that the POP3 server can be replaced by an internet message access protocol 4 (IMAP4) server which can perform all of the POP3 functions and features additional functions for flexibility and efficiency. As mentioned before, the computers 100a-f each have an e-mail client that includes a POP3 component. The POP3 component on the computer 100d-f can contact the POP3 server on the local ISP server 120b and retrieve messages for the user logged in to the client on the respective computer 100d-f.

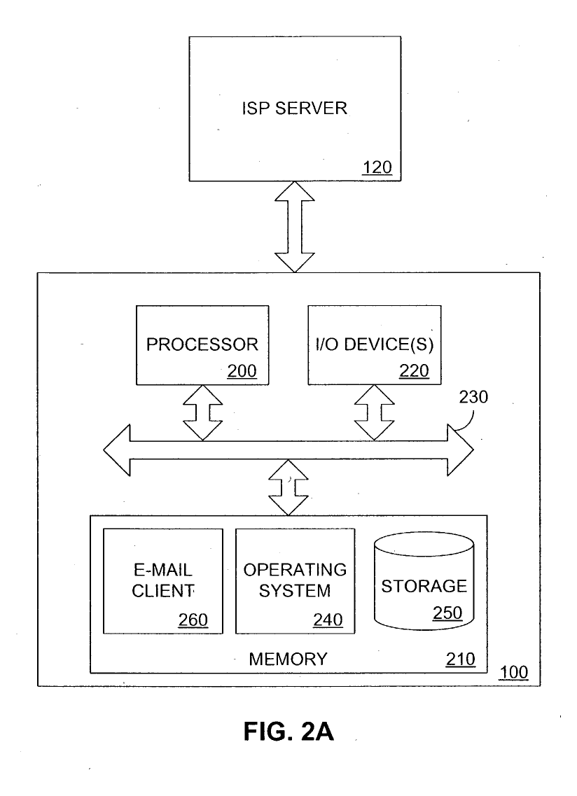

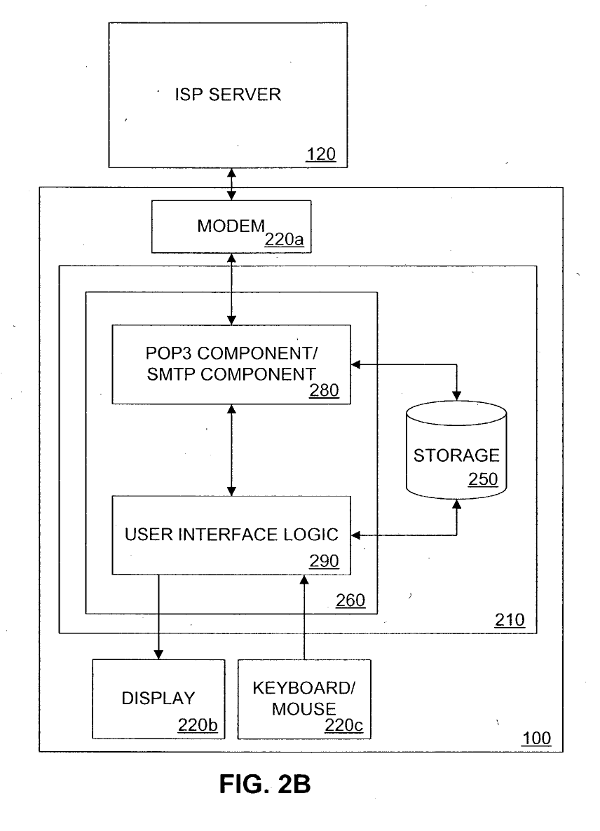

Referring now to FIG. 2A, shown is block diagram of an embodiment of a computer system in accordance with the present invention. As known to those skilled in the art, a computer system typically includes a processor 200, memory 210 and input/output (I/O) device(s) 220, all communicating over a bus 230. The memory typically includes the operating system 240 and non-volatile storage 250. The operating system is typically stored in non-volatile memory while the computer 100 is turned off, and loaded into volatile memory upon start-up, where it can be executed by the processor 200. In the present embodiment, the memory includes an e-mail client 260 which enables the computer to send/receive e-mail messages to/from the ISP server 120 through an I/O device 220 such as an analog modem, DSL modem, ISDN modem or ethernet card, among others. The e-mail client 260, as discussed above, typically includes a retrieval component (such as POP3) to receive e-mail, a transfer component (such as SMTP) to send e-mail, and some sort of user interface logic to format the output to provide a display that can be understood by the computer user.

Referring now to FIG. 2B, shown is a more detailed diagram of the e-mail client 260 of FIG. 2A. As mentioned above, the e-mail client includes POP3 and SMTP components 280. As one skilled in the art will recognize these protocols merely relate to retrieving and sending e-mail. As such, it is intended that other protocols which operate to send and retrieve e-mail, such as IMAP4, are intended to be included herein. The POP3 component 280 in this embodiment typically downloads e-mail from the ISP server 120 through an I/O modem device 220a, and stores the e-mail in non-volatile storage 250. Moreover, the POP3 server in this embodiment can be set up to retrieve messages for more than one e-mail account.

User interface logic 290 included within the e-mail client 260 can retrieve the messages from the non-volatile storage, format the information, and send the formatted information to the I/O display device 220b. In particular, user interface logic 290 of this embodiment, among others, of the present invention is configured to parse the data retrieved from non-volatile storage 250. Specifically, user interface logic 290 can separate e-mail messages according to an associated “To:” e-mail address or “From:” e-mail address, and display multiple mailboxes corresponding to several e-mail addresses. Moreover, user interface logic 290 can further parse the data retrieved according to e-mail “threads.” In other words, a series of back-and-forth e-mail replies can be linked by user interface logic 290. Typically using threading, as is known in the art, a parent message creates a global unique identifier (GUID), and each child message spawned from the parent references this GUID and a link is inserted to the parent message. Moreover, when a child message is spawned, the e-mail client on the machine that created the child message inserts a link into the parent message, linking each child that is spawned from that e-mail client. User interface logic 290 can also be configured to display summary information from each of the mailboxes, such as how many messages are contained in each of the subfolders of the mailboxes. One skilled in the art will recognize that in practice, user interface logic 290 typically calls various functions within the operating system that are relayed through the processor 200 (FIG. 2A) before being sent to the display device 220b.

When a user chooses to read a message, the user merely uses an input device 220c to select a message from the active folder. Once selected, a “read” window will open, enabling the user to read the text associated with the selected message. Upon a user choosing to write a new e-mail or reply to an e-mail, user interface logic 290 in one embodiment, among others, of the present invention will open a “write” window that will enable the user to compose a message. Moreover, user interface logic 290, upon opening the window, will stamp the message with the currently active mailbox, or alternatively, will stamp a reply from the e-mail address at which it was received. One skilled in the art will understand that the user typically inputs the e-mail on an I/O device 220c such as a keyboard or mouse. Moreover, one skilled in the art will recognize other input devices on which text and commands can be input, such as voice recognition software, and each of the alternative input devices are intended to be included within the scope of this invention. Upon completion of the e-mail, the user can instruct the e-mail client to send the e-mail. User interface logic 290 will send the message to non-volatile storage 250, if the user has set up the option to save sent messages, and transfer the message to the SMTP component 280. The SMTP component 280 will then transfer e-mail to the ISP server 120 over the modem 220a, if the computer is on-line. If the computer is not on-line the SMTP component 280 will send the message to be stored in non-volatile storage 250 pending being sent the next time the computer is connected to the ISP server 120. As known to those skilled in the art, there are many different ways to facilitate reading and writing a message, and the invention presented herein should not be limited to a particular method for displaying the text of a message or for composing a message.

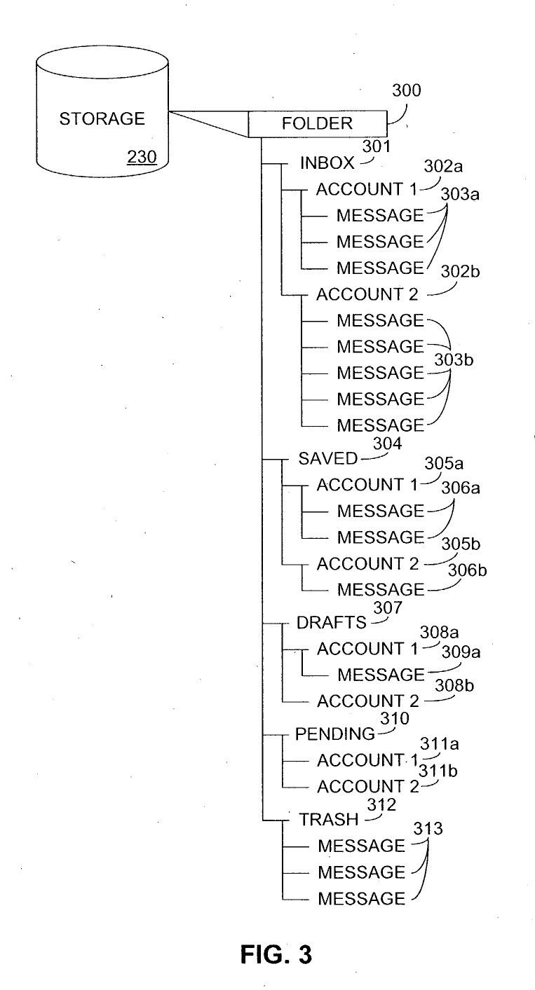

Referring now to FIG. 3, shown is an embodiment, among others, of a data structure of the non-volatile storage 250 corresponding to the e-mail client 260 and user interface logic of FIG. 2B. Within the non-volatile storage 250 is included a e-mail client folder 300 which corresponds to all of the information regarding the e-mail client 260. The folder 300 can contain other folders and messages. In this embodiment, the folder includes a link (through the header) to an “Inbox” folder 301. The “Inbox” folder 301, is further linked to folders for “Account 1” 302a and “Account 2” 302b. These Account folders 302a, 302b each correlate to an e-mail address. For example, in a household environment, “Account 1” 302a might be a husband's e-mail address, while “Account 2” is a wife's e-mail address. Each of the account folders 302a, 302b contain links to messages 303a, 303b. The messages are linked according to which “Inbox” folder they belong. As such, all of the messages 303b sent to “Account 2” are linked to the “Account 2” folder 302b. Moreover, each of the account folders 302a, 302b shown could contain links to message “Thread” folders (not shown). These “Thread” folders could be set up to keep track of a back-and-forth series of messages between users, such that a user would be able to keep track of things such as how the conversation started, when the last response occurred, exactly what was said during the back-and-forth series, etc.

The e-mail client folder 300 can further include a relationship with a “Saved” folder 304, which stores messages for later use, clearing a user's “Inbox” folder 301 of old e-mail messages. Like the “Inbox” folder 301, the “Saved” folder 304 includes a link to “Account 1” and “Account 2” folders 305a, 305b. These account folders 305a, 305b each contain messages 306a, 306b that relate to the respective account folders 305a, 305b which link the messages 306a, 306b.

The e-mail client folder 300 can further include a link to a “Drafts” folder 307, which stores drafts of e-mail messages that the user has not chosen to send to the recipient yet. Like the “Inbox” 301 and “Saved” folders 304, the “Drafts” folder 307 includes links to folders 308a, 308b for each of the accounts entered into the e-mail client, but are parsed according to the “From” field instead of the “To” field. These account folders 308a, 308b contain links to any respective outgoing messages 309a which have been saved in the “Drafts” folder 307 for later use in the present example, “Account 1” folder 308a contains a link to a message 309a which has been saved by a user associated with the “Account 1” folder 308a.

The e-mail client folder 300 can further include a link to a “Pending” folder 310, which is used to save drafts of messages that the user has chosen to send, but the e-mail client is unable to send because the computer 100 (FIG. 2) is not connected to the ISP server. The “Pending” folder 310 includes links to account folders 311a, 311b dividing the “Pending” folder into the number of accounts which have been entered into the e-mail client. No pending messages are shown in this embodiment, however, when a message is pending it will be linked under the account folder 311a, 311b from which it is to be sent, similarly to the “Drafts” folder 307.

The e-mail client folder 300 can further include a link to a “Trash” folder 312, which includes messages which are intended to be thrown away. In this embodiment, among others, of the present invention, the “Trash” folder 312 is a universal trash folder that does not contain any partitions or links to any of the accounts which have been entered into the e-mail client. Instead, all of the messages are thrown together, as they would be in a family's garbage. In alternative embodiments, a user can set up an option to send messages to the “trash” folder immediately after closing a “read” window that was used to read a message from the “inbox,” unless the user requests to place the message in another folder. Moreover, when a message is removed from the “Trash” folder it is permanently deleted. The “Trash” folder can be set up to remove messages regularly, or upon request by the user.

One skilled in the art will recognize that there are many ways to implement each of these folders, and that particular details of the folders are not critical to the invention disclosed herein. Moreover, there exist myriad other folders that may be included in the e-mail client in conjunction with the present invention. All such variants are intended to be included within the scope of the present invention.

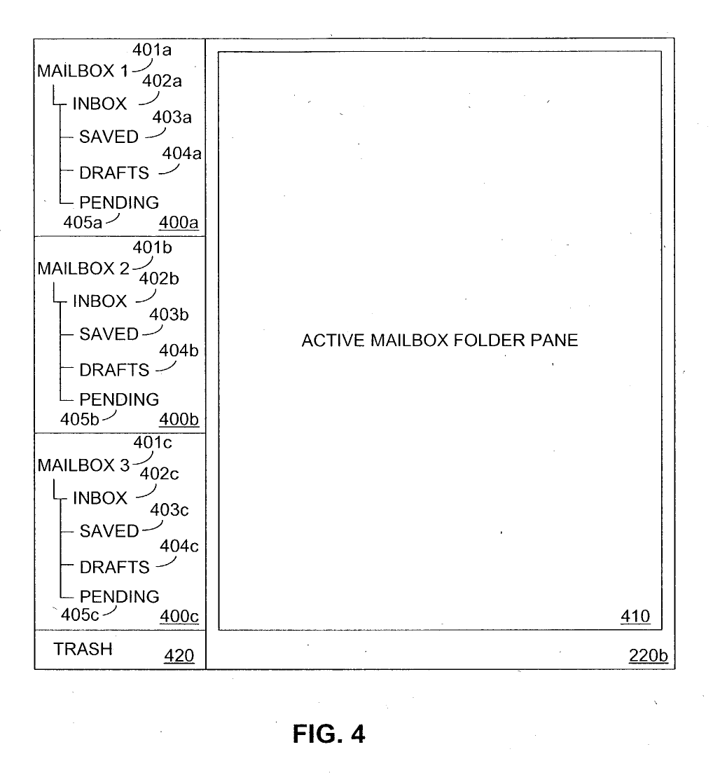

Referring now to FIG. 4, shown is an embodiment, among others, of a generic display 220b output to the user by user interface logic 290 (FIG. 2B). Designations for each of the e-mail accounts entered into the e-mail client are displayed separately on the left side of the display 220b. The display for the default e-mail account 400a is typically shown in the first position at the upper left of the display 220b. The display for the default e-mail account includes a mailbox name 401a, which can be customized by the user. For example, the mailbox might be a work mailbox, and so the user would label the mailbox as “work stuff.” Appearing below the mailbox name typically will be the “Inbox” folder designation 402a corresponding to the mailbox designation. Below the “Inbox” folder designations 402a, there can be sub-folder designations such as “Saved” 403a, “Drafts” 404a, and “Pending” 405a. By selecting any one of these folder or sub-folder designations, the user will be enabled to view the contents of that associated folder or sub-folder through the active mailbox folder pane 410. Moreover, each of the alternative e-mail accounts 400b, 400c may have similar structures, and the active mailbox folder pane 410 will display the contents of those folders and sub-folders upon selection of those folders or sub-folder designations.

The display 220b will also include a collective “Trash” area representation 420. Here items that have been put in the trash will be stored collectively without any parsing according to whose account the trashed message belongs to. Moreover, if a user wishes to view the items in the “Trash” area, the user may-select the “Trash” area representation 420 and the active mailbox folder pane 410 will display a summary version of the messages contained within the “Trash” area.

One skilled in the art will recognize that the e-mail account displays 400a, 400b, 400c can provide short summary information about the contents of each folder, such as the number of messages contained within that folder, the presence of a new message, etc. Moreover, one skilled in the art will recognize that typically when a folder 402a-c, 403a-c, 404a-c, 405a-c is selected, a list including further summary information will be provided in the active mailbox folder pane 410. Typically this further summary information can include an indication of whether or not the message has been read, who the message is from, when it was sent, a subject, etc. Moreover, the active mailbox folder pane 410 could include a preview pane that enables the user to see part of the text of a message when the message is highlighted by the user. It should be understood that each of these variances upon this mailbox are intended to be included within the present invention, since the display depends highly on stylistic preferences.

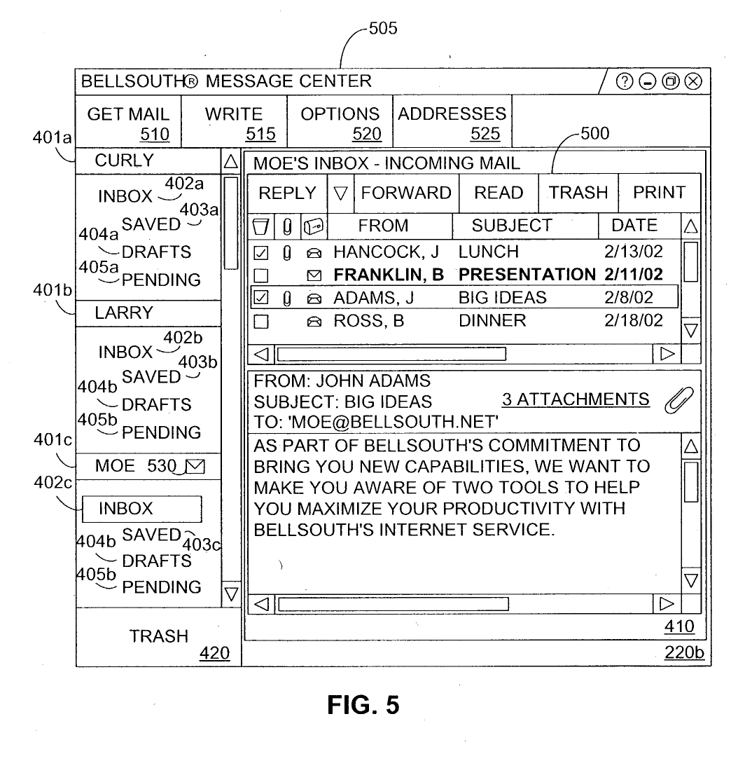

Referring now to FIG. 5, shown is a detailed display window of an embodiment, among others, of the present invention. Here the mailbox representations 401a-c relating to each e-mail address entered into the e-mail client have been separated and named by the user(s) as “Curly,” “Larry,” and “Moe,” respectively. Each of the mailbox representations 402a-c contain an “Inbox” folder representation 402a-c, a “Saved” folder representation 403a-c, a “Drafts” folder representation 404a-c, and a “Pending” folder representation 405a-c. A box around “Inbox” representation 402c indicates that this “Inbox” representation 402c has been selected/highlighted, and that the active mailbox is the mailbox named “Moe.” Thus, the active mailbox preview pane 410 shows “Moe's Inbox.” As one skilled in the art will recognize, this embodiment includes a preview pane, such that at least a portion of the highlighted message can be viewed in the bottom section of the active mailbox folder pane 410. One skilled in the art will recognize many functions included in the active mailbox folder pane 410, such as the user selectable buttons 500 at the top of the active mailbox folder pane 410. Each of these user selectable buttons 500 relates to a function that can be performed on the highlighted message. For example, if the user selected the “Reply” button, user interface logic 290 (FIG. 2B) would force the display of a window in which the user could compose a response to the highlighted message. Moreover, user interface logic 290 could automatically fill in the “From” field of the composition window with the mailbox to which the original message was sent, instead of filling in a default mailbox. Similarly, if the user wished to forward the message to a friend or colleague, the user could select the “Forward” button, and select the “Read” button to open a new window to read the message in its entirety. Basic aspects of these functions are familiar to those skilled in the art. In alternative embodiments, the mailbox representations 401a-c may be password protected, such that a user cannot switch between mailbox representations 401a-c and read another user's message without providing a password.

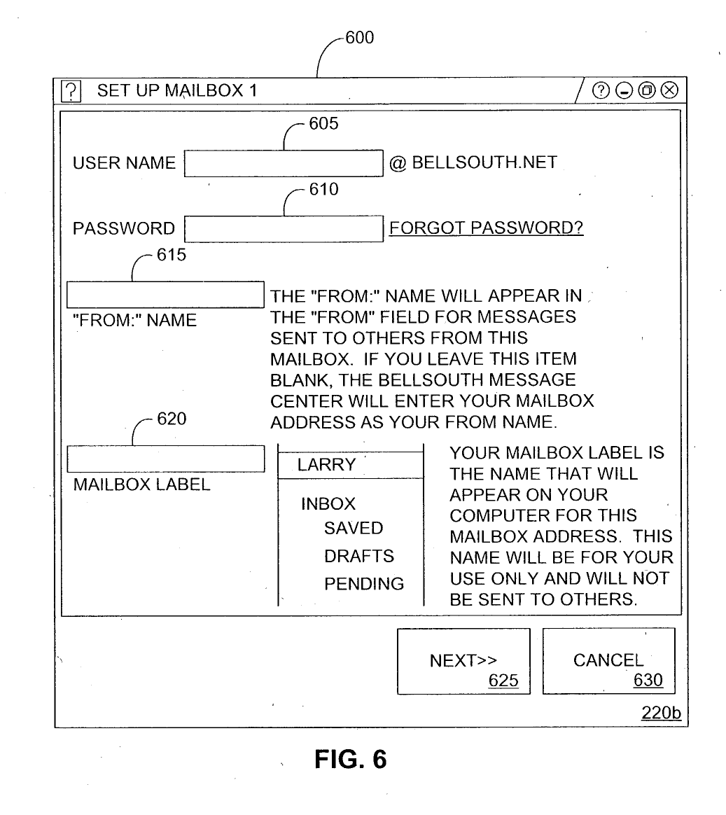

Further, the “Message Center” representation 505 typically includes several user selectable buttons (or menus) such as “Get Mail” 510, “Write” 515, “Options” 520, and “Addresses” 525. The “Get Mail” button 510 typically retrieve mail from the POP3 server on the ISP server 120 (FIG. 2B). The “Write” button 515 typically opens a new window enabling the user to compose a new message. Moreover, user interface logic can fill in the “From:” field of the new window with the presently selected mailbox, instead of merely the default mailbox as done in other e-mail clients. The “Options” button 520 typically provides the user with a set of setup options where the user can change viewing preferences, mailboxes which are being checked, etc. Referring now to FIG. 6, shown is a sample screen shot of an embodiment, among others, of a mailbox set-up window 600. This window typically appears upon installation of the e-mail client 260 (FIG. 2A), enabling a user to create a number of different mailbox representations 401a-c that correlate to a number of different e-mail addresses. As mentioned above, this screen (or a similar screen) may be accessed later through the “Options” button 520 (FIG. 5) of the message center window 505 (FIG. 5). Typically, a user would first enter a username 605 and password 610 corresponding to an e-mail address and system password for an e-mail server on which the user has an e-mail account. The user may then enter a “From:” name 615. The “From:” name 615 is typically a name the user chooses which will be displayed to recipients of e-mail from the associated mailbox. Finally, the user may enter a mailbox label 620. The mailbox label 620 can be used to differentiate between multiple mailboxes which are shown to the user in accordance with an embodiment, among others, of the present invention. When finished, the user can select the “Next” button 625 to complete creation or receive more options. Alternatively, the user may select the “Cancel” button 630 to cancel the creation/edit of the mailbox. It should be recognized to one of skill in the art that there are a multitude of options and preferences that can be gathered, such as, e.g., mailbox folder and sub-folder names, e-mail accounts on other servers (i.e., setting the e-mail client up to check POP3 and SMTP accounts from servers other than “bellsouth.net”), rules for treating incoming mail, etc. and that each of these is intended to be included within the present disclosure.

Referring again to FIG. 5, the “Addresses” button 525 typically produces a window which includes all of the e-mail addresses for contacts and e-mail lists which have been entered into the e-mail client. Again, one skilled in the art will recognize that there are many nominal variations that can be made upon the detailed display shown in FIG. 5, and that such variations are intended to be included within the present invention.

Further, the e-mail client can include an automatic message retrieval from the POP3 server. In alternative, embodiments, each mailbox can be set up with the same or different automatic message retrieval rates. In other words, for example, a first mailbox could retrieve messages every 15 minutes, while a second mailbox could retrieve messages every hour. Upon retrieving new messages user interface logic can include a notification to the user that a new message has been received. One skilled in the art will recognize that typically the notification is in the form of a message icon appearing in the tray, or some form of aural notification. In one embodiment, among others, of the present invention, the notification could include notification of which account has received new mail. For example, in FIG. 5 there is a new message icon 530 next to the representation of the mailbox labeled “Moe” 401c. Thus a user who may not be associated with the account will not have to open the message or inbox to know to whom the new message belongs. Moreover, the message will automatically be placed in the correct mailbox such that users not associated with the mailbox will not have to sort the incoming e-mail.

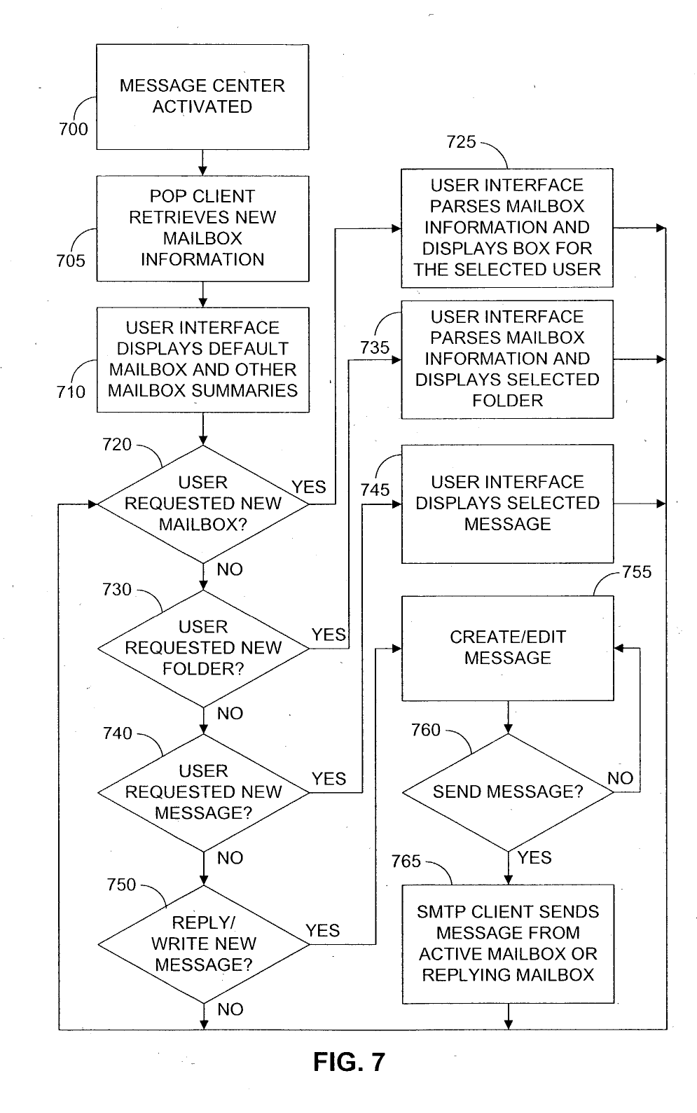

Referring now to FIG. 7, shown is a flowchart illustrating an embodiment, among others, of the operation of the present invention. In step 700, the e-mail client 260, or message center, is activated. Typically the e-mail client is activated by the user, but the computer 100 may automatically activate the e-mail client upon startup in some situations. In step 705, user interface logic retrieves the mailbox information from the non-volatile storage 250. In step 710, user interface logic 290 parses the mailbox information retrieved from the non-volatile storage 250. This parsing involves separating the messages into their respective mailboxes, and further separating it into separate folders. In step 710, user interface logic 290 uses the parsed information to instruct the display 220b to display all of the mailboxes 401a-c and mailbox summaries and active mailbox folder pane 410.

In step 720, the e-mail client 260 checks to see if a request has been received by the user requesting user interface logic 290 display a new mailbox. If a request has been received to display a new mailbox, in step 725 user interface logic 290 parses the information contained within the non-volatile storage 250 and puts the new mailbox information in the active mailbox folder pane. If the e-mail client 260 has not received a request for a new mailbox from the user, in step 730 the e-mail client 260 checks to see whether the user has requested a new folder. If there has been a request for a new folder, in step 735 user interface logic 290 parses the information for the new folder and displays the summary information for that folder to the user in the active mailbox folder pane 410. If the e-mail client 260 has not received a request for a new folder from the user, in step 740 the e-mail client 260 checks to see whether the user has requested a new e-mail message. If the user has requested a new e-mail message, in step 745 user interface logic 290 retrieves the message and displays the message for the user. Typically, the message will be displayed in a new window enabling the user to review the complete message, however, the message can be displayed to the user in myriad forms.

In the event that the user has requested none of the above, the e-mail client 260 in step 750 checks to see whether the user has selected to reply to a message or write a new message. If the user has selected to write a new message or reply to a message, in step 755, user interface logic 290 will enable the user to create or edit the message. Moreover, it should be noted that this create/edit message step 755 will be repeated until the user sends or cancels creation/editing process for a message. In step 760, user interface logic 290 will wait until the user selects to send the message. When the user selects to send the message, user interface logic 290 will transfer the message to the SMTP component. The message can be stamped with a “From” address (or return address) according to which mailbox was active when the user selected to write a new message. If the message is a reply, the message can be stamped with a “From” address according to which mailbox the original (parent) message was sent to. In each of steps 725, 735, 745 and 765, the step returns to checking upon completion of the task selected by the user. The flowchart outlined above is implemented in XML in one embodiment, among others, of the present invention. However, one skilled in the art will recognize that the present invention can be implemented in a variety of manners and all such manners are intended to be included within the scope of the present invention.

Process and function descriptions and blocks in flow charts can be understood as representing, in some embodiments, modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention. In addition, such functional elements can be implemented as logic embodied in hardware, software, firmware, or a combination thereof, among others. In some embodiments involving software implementations, such software comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a computer-readable medium can be any means that can contain, store, communicate, propagate, or transport the software for use by or in connection with the instruction execution system, apparatus, or device.

It should be emphasized that the above-described embodiments of the present invention are merely possible examples of implementations set forth for a clear understanding of the principles of the invention. Many variations and modifications may be made to the above-described embodiment(s) of the invention without departing substantially from the principles of the invention. All such modifications and variations are intended to be included herein within the scope of this disclosure and the present invention and protected by the following claims.

What is claimed is:

1. An e-mail client, comprising:
a message retrieval component operable to retrieve a plurality of messages for a plurality of e-mail accounts from at least one e-mail server and store the plurality of messages in a storage system; and
a user interface logic operable to parse the plurality of messages stored in the storage system according to an e-mail address associated with a respective message, and cause the plurality of parsed messages to be separately displayed to a user on a computer display.

2. The e-mail client of claim 1, wherein the user interface logic is further operable to parse the plurality of messages according to at least one thread to which a subset of the plurality of messages belong.

3. The e-mail client of claim 1, wherein the storage system is operable to store the plurality of e-mail messages in a plurality of folders which are operable to be parsed by the user interface logic.

4. The e-mail client of claim 3, wherein a first folder is an inbox folder, in which all new messages retrieved by the retrieval component are stored.

5. The e-mail client of claim 3, wherein a second folder is a saved folder, in which the user can save at least one message.

6. The e-mail client of claim 3, wherein a third folder is a draft folder, in which all unfinished drafts of outgoing e-mail can be stored.

7. The e-mail client of claim 3, wherein a fourth folder is a pending folder, in which all sent mail can be stored until transferred to the e-mail server.

8. The e-mail client of claim 1, wherein the user interface logic is operable to receive a request to send a message and stamp the message with one of the plurality of e-mail accounts based upon which of the plurality of mailboxes were highlighted by the user upon requesting to send the message.

9. The e-mail client of claim 1, wherein the user interface logic is operable to receive a request to reply to a message and stamp the message with one of the plurality of e-mail accounts based upon which of the plurality of e-mail accounts received the message to which the user intends to reply.

10. The e-mail client of claim 1, wherein the user interface logic is operable to receive a request from the user to trash a message, and send the message to a trash folder.

11. The e-mail client of claim 10, wherein the trash folder is shared by each of the plurality of e-mail accounts.

12. The e-mail client of claim 1, wherein each of the e-mail addresses are different aliases for the same person.

13. The e-mail client of claim 1, wherein each of the e-mail addresses are different members of the same household who use a single computer to retrieve email.

14. The e-mail client of claim 1, further comprising:
a message transfer component, operable to receive an outgoing message from the user interface and transfer the message to the e-mail server.

15. The e-mail client of claim 14, wherein the user interface logic is operable to label the outgoing message with one of a plurality of account addresses.

16. The e-mail client of claim 15, wherein the user interface logic is operable to label a reply message from the account address to which a parent message associated with the reply message was received.

17. The e-mail client of claim 15, wherein the user interface logic is operable to label a new message from an account address that was highlighted by the user upon selecting to create the new message.

18. The e-mail client of claim 15, wherein the user interface logic is operable to forward an original message, and to label the forwarded message from an account address to which the original message was received.

19. A method of receiving e-mail, comprising:
requesting any new messages for at least two e-mail accounts from at least one e-mail server;
storing the new messages for said at least two e-mail accounts in a data structure;
parsing the data structure to separate the messages based on said at least two e-mail accounts; and
displaying a summary of the parsed data structure to a user according to a plurality of folders.

20. The method of claim 19, further comprising:
formatting the parsed data structure such that said at least two e-mail accounts appear separately when displayed.

21. The method of claim 19, further comprising:
receiving a request to display the contents of one of the plurality of folders; and
displaying a more detailed summary including a list of message headers of the parsed data structure corresponding to said one of the plurality of folders.

22. The method of claim 21, further comprising:
receiving a second request to display a message associated with one of the message headers; and
displaying said message.

23. The method of claim 19, wherein the user uses each of said at least two e-mail accounts as aliases.

24. The method of claim 19, wherein the user is one of a plurality of users that comprise a household, the household using a single computer for each of the plurality of users.

25. The method of claim 24, wherein each of the plurality of users are associated with at least one of said at least two e-mail accounts.

26. The method of claim 19, further comprising:
receiving a request to send an outgoing message; and
sending the outgoing message through said at least one e-mail server.

27. The method of claim 26, further comprising:
labeling the outgoing message with one of said at least two e-mail accounts based upon whether the outgoing message is a reply, forwarded message or new message.

28. The method of claim 27, wherein the reply is labeled as being from the account to which a parent message associated with the reply was sent.

29. The method of claim 27, wherein the forwarded message is labeled as being from the account to which a parent message associated with the forwarded message was sent.

30. The method of claim 27, wherein the new message is labeled as being from the account which was selected when a request to create the new message was received.

31. The method of claim 19, further comprising:
receiving a request to trash an unwanted message;
sending the unwanted message to a universal trash folder.

32. The method of claim 19, wherein the data structure includes a plurality of folders which comprise all previously retrieved messages which have not been permanently deleted.

33. A computer readable medium having a program for an e-mail client, the program comprising the steps of:
requesting any new messages for at least two e-mail accounts from at least one e-mail server;
storing the new messages for said at least two e-mail accounts in a data structure;
parsing the data structure to separate the messages based on said at least two e-mail accounts; and
displaying a summary of the parsed data structure to a user based on a plurality of folders.

34. The method of claim 33, further comprising:
receiving a request to trash an unwanted message; and
sending the unwanted message to a universal trash folder.

35. The method of claim 33, wherein the data structure includes a plurality of folders which comprise all previously retrieved messages which have not been permanently deleted.

36. The method of claim 33, further comprising:
formatting the summary display such that said at least two e-mail accounts appear separately when displayed.

37. The method of claim 33, further comprising:
receiving a request to display the contents of one of the plurality of folders; and
displaying a more detailed summary including a list of message headers of the parsed data structure corresponding to said one of the plurality of folders.

38. The method of claim 37, further comprising:
receiving a second request to display a message associated with one of the message headers; and
displaying said message.

39. The method of claim 33, wherein the user is associated with each of said at least two e-mail accounts.

40. The method of claim 33, wherein the user is one of a plurality of users that comprise a household, the household using a single computer for each of the plurality of users.

41. The method of claim 40, wherein each of the plurality of users are associated with at least one of said at least two e-mail accounts.

42. The method of claim 33, further comprising:
receiving a request to send an outgoing message; and
sending the outgoing message.

43. The method of claim 42, further comprising:
labeling the outgoing message with one of said at least two e-mail accounts based upon whether the outgoing message is a reply, forwarded message or new message.

44. The method of claim 43, wherein the reply is labeled as being from the account to which a parent message associated with the reply was sent.

45. The method of claim 43, wherein the forwarded message is labeled as being from the account to which a parent message associated with the forwarded message was sent.

46. The method of claim 43, wherein the new message is labeled as being from the account which was selected when a request to create the new message was received.
